(19) United States
(12) Patent Application Publication
(10) Pub. No.: US 2015/0271642 A1
(43) Pub. Date: Sep. 24, 2015

(54) WIRELESS NETWORK SCHEDULING AND LOCATING

(71) Applicant: RAYMOND & LAE ENGINEERING, INC., Fort Collins, CO (US)

(72) Inventors: Donald M. Raymond, Fort Collins, CO (US); Jon Cox, Fort Collins, CO (US)

(21) Appl. No.: 14/664,388

(22) Filed: Mar. 20, 2015

Related U.S. Application Data
(60) Provisional application No. 61/968,914, filed on Mar. 21, 2014.

(51) Int. Cl. H04W 4/02; H04W 16/18

(52) U.S. Cl. CPC H04W 4/023; H04W 16/18; H04W 84/18

(57) ABSTRACT

A method and system for a scheduled communication system and location of sensor method and system. A plurality of sensors are enabled to communicate to a central hub or communications center. Each of the sensors may be given a defined time slot in which to communicate. A routing table may be used to define the time slots for each of the sensors. Each of the sensors will be able to connect to a base station. The base station is enabled to update each of the wireless sensors. The update will be accomplished via a wireless network. A portable device, such as a smart phone or similar specialized device, is utilized to hone in on the location of each particular sensor. The device is used to locate particular sensors. Sensor placement may be provided through indicators of signal quality and estimated battery life dependent on location of the sensor.

### BACKGROUND OF THE INVENTION

1. Field of the Invention

The invention relates generally to wireless networks.

2. State of the Prior Art

In wireless networks the problem of allocating transmission rights to subsets of network users or devices at each time and under different channel qualities is generally known as a scheduling problem. It arises in wireless environments because of three main reasons related to the fundamental properties of the wireless medium. Specifically, scheduling is mandatory since in wireless environments (i) communication resources are shared among geographically separated users, (ii) transmissions may interfere with each other, and (iii) transmissions undergo impairments, such as fading, attenuation, etc.

The scheduling issues at any given time are about identifying the user that are allowed to transmit and their corresponding transmission power levels and rates. Often, a delay mechanism may be used to control traffic in a wireless network. For instance, each sensor may be on a fixed interval timer for transmissions. An interval for one timer may be different than an interval for another timer. In this manner, a transmitter can have a certain probability of having its transmission go through occasionally or semi-regularly, if not always. This type of scheduling accordingly may lead to communication collisions. The number of collisions is statistically related to the number of sensors in a particular network. Naturally, even a system with just two sensors, where those two sensors have different timing, will result in collisions.

### SUMMARY OF THE INVENTION

Additional objects, advantages, and novel features of the invention are set forth in part in the description that follows and others will become apparent to those skilled in the art upon examination of the following description and figures or may be learned by practicing the invention.

To achieve the foregoing and other objects in accordance with the purposes of the present invention, as embodied and broadly described herein, an embodiment of the invention may therefore comprise a method of locating a sensor in a network comprising a plurality of sensors and a base unit, the method comprising via a location device, emitting a signal detectable by at least one of the plurality of sensors, activating a microphone in the at least one of the plurality of sensors, via a user, moving the device from a first location to a second location, via the at least one of the plurality of sensors, detecting the signal emitted by the location device, the via the at least one of the plurality of sensors, transmitting a responsive signal to indicate proximity of the locating device to the at least one of the plurality of sensors.

An embodiment of the invention may further comprise a method of locating a sensor in a network comprising a plurality of sensors and a base unit, the method comprising via at least one of the plurality of sensors, emitting a location signal, via the location device, detecting the location signal, displaying a location metric related to the detected location signal on the location device, via a user, moving the location device from a first location to a second location, if the second location is closer to the at least one of the plurality of sensors than the first location, via the location device, communicating with the at least one of the plurality of sensors to modify the location signal, and via the at least one of the plurality of sensors, modifying the location signal.

An embodiment of the invention may further comprise a system for locating a sensor in a network, the system comprising a base unit, a mobile location device enabled to transmit a signal, and a plurality of sensors comprising a microphone wherein each sensor is enabled to detect the signal transmitted by the location device and to transmit a responsive signal to indicate proximity of the mobile location device, wherein the responsive signal varies in strength depending on the proximity of the mobile location device to a sensor that is transmitting the responsive signal.

An embodiment of the invention may further comprise a system of locating a sensor in a network, the system comprising a plurality of sensors wherein each of the plurality of sensors is enabled to emit a location signal and modify the location signal pursuant to a command, and a mobile location device enabled to detect the location signal, display a location metric related to the detected location signal and command a sensor of the plurality of sensors to modify the location signal pursuant to the location metric.

An embodiment of the invention may further comprise a method of estimating battery life in a wireless device in a network comprising a plurality of sensors and a base, the method comprising via the base, the base comprising a computing device, calculating the total number of clock cycles that one of the plurality of sensors has been awake, and calculating the power consumption of the one of the plurality of sensors according to a predefined algorithm.

An embodiment of the invention may further comprise a method of optimizing power in a wireless network, the network comprising a plurality of wireless sensors and a base unit, the method comprising by the base unit, calculating a power metric for each of the sensors of the plurality of wireless sensors, for each sensor of the plurality of wireless sensors, establishing a signal route for transmissions that utilizes the least power according to the power metric, scheduling an awake time for each sensor in the plurality of sensors in a unique time slot during a predefined period of time.

An embodiment of the invention may further comprise method of optimizing placement of sensors in a wireless network, the network comprising a plurality of wireless sensors and a base unit, the method comprising, via a user, placing a first of the plurality of sensors in a placement mode, via the first of said plurality of sensors, emitting a human perceptible signal wherein the signal indicates one of a signal quality and an estimated battery life for the sensor, via the user, and mounting the sensor.

### BRIEF DESCRIPTION OF THE DRAWINGS

The accompanying drawings, which are incorporated in and form a part of the specification, illustrate the preferred embodiments of the present invention, and together with the written description and claims, serve to explain the principles of the invention. In the drawings:

FIG. 1 shows a table for sensor scheduling.

FIG. 2 shows a sensor using a signal to transmit to a location device.

FIG. 3 shows a barcode of a scanner.

FIG. 4 shows a flow diagram for locating a sensor.

FIG. 5 shows a flow diagram for locating a sensor using a signal from the sensor.

FIG. 6 shows a plug and play functionality in a sensor system.

FIG. 7 shows a network with mains power.

FIG. 8 shows a network with a sensor connected to mains power.

FIG. 9 shows a sensor.

FIG. 10 shows an example of physical sensor locations.

### DETAILED DESCRIPTION OF THE PREFERRED EMBODIMENTS

An embodiment of the invention comprises a scheduled communication system. A plurality of sensors are enabled to communicate to a central hub or communications center. Each of the sensors may be given a defined time slot in which to communicate. A routing table may be used to define the time slots for each of the sensors. The use of defined time slots aids in the prevention of sensor interference with each other. For instance, instead of a sensor having a random periodic communications schedule, each sensor will be schedule so that no other sensor is communicating at the same time. As an example, if a first sensor communicates every third of a second and a second sensor communicates every half second, then there will be an interference every second. It is noted that this is an example of interference using a very simple periodic scheme. Those skilled in the art will understand that variable periods may be used or other more complicated schemes. However, the probability of interference does not vanish, or go to zero, with more complicated schemes. The embodiments of the invention, however, eliminate the probability of interference.

The use of scheduling of sensors in defined time slots also preserves power, by reducing power usage, of the scheduled sensors. This may be especially important in the case where a sensor needs to act as a repeater. As is understood by those skilled in the art, a repeater is a device that receives a signal and retransmits it at a higher level or higher power. This may include transmitting a signal to the other side of an obstruction, so that the signal can cover longer distances. Based on a defined schedule, a sensor will know when to wake up and receive power from another device. As such, a sensor can be asleep much longer. Each sensor will have an internal clock that is precisely synchronized with a base station to allow accurate time slices. Synchronization in conjunction with defined scheduling allows for a larger number of sensors to communicate in a given time period. Accordingly, it is possible that only one sensor at a time is awake and communicating. Wake up times will be staggered according to the schedule. This provides the mentioned energy savings as well as a reliability of information. As more sensors are added to a network, coverage improves and additional paths due to synchronization and scheduling increase reliability. There is no increase in signal conflict, or interference, due to the scheduling of sensor transmissions and associated awake times. Throughout this description, the base unit may be described as a base station, which terms are used interchangeably.

It is understood that in order for accurate scheduling of sensor activity, that the wireless network needs to synchronize the clocks of the sensors, which will reside in a chip or other device in the sensor. Transmission changes take time. A ‘start time’ beacon, or signal will be initiated by a base unit. After a period of time, for instance two or three minutes, a ‘stop beacon’, or signal, will be sent by the base unit. The time between the beacons is used to synchronize the clocks of the sensors. The time between the beacons is several orders of magnitude longer than the maximum latency of a transmission and therefore the transmission latency can be assumed to be zero, respectively. Each sensor must have an accurately synchronized time clock. The base station will send out a synchronization signal. After a significantly longer period of time than the latency of the transmission, the base unit will send out a second signal. The time between the two signals is known. This allows for an accurate synchronization.

As noted throughout this description, battery life of a sensor is an aspect that requires monitoring. A low battery needs to be serviced to ensure continued proper operation of a sensor. A wireless network may indicate battery life based on the battery voltage. However, with certain types of batteries, such as lithium, the voltage levels may be relatively constant until the battery is less than 10% charged, for example. In an embodiment of the invention, the total amount of energy drawn from a battery is monitored. This may be accomplished by tracking the total clock cycles that a sensor is awake and the known power use of a sensor. A method of quantifying energy is provided in this description. The calculation will include the time, power of transmissions, time of transmissions. It is understood that other factors which may indicate battery usage at a certain level may be used. The total battery power available in a battery may be used as an amount against which to compare the power used. When a new battery is placed in a sensor, the battery level can be reset in a base to a predefined level based on the type of battery used and known characteristics of a battery used. The system may also sense an initial level of a battery and use the sensed level of a battery against the determined power usage of a sensor.

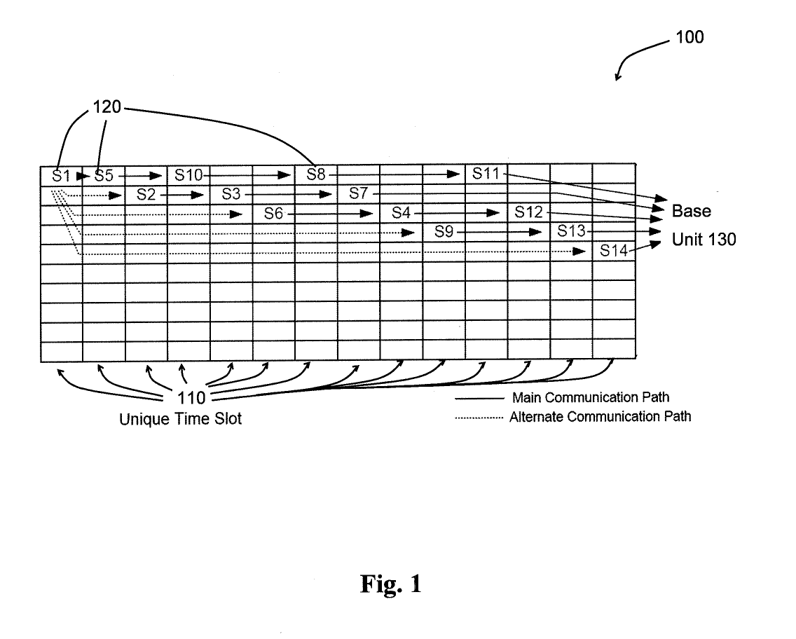

FIG. 1 shows a table for sensor scheduling. A Sensor Time Scheduler and Routing table 100 shows a plurality of time slots 110. Each sensor will have a specified time slot 110. In that time slot 110, the sensors communicate with the base station as well as any sensors that it is acting as a repeater for. The routing table 100 shows an address and a mask for each sensor 120. The masks are selected such that any device that acts as a repeater (for instance, sensor S4 acts as a repeater for sensor S6) knows how to forward the address of the sensor that it is acting as a repeater for. Each sensor will have a unique address. The routing table collates the time slots and allows the mask to match the address of the appropriate sensor. The mask will indicated additional time slots for which a repeater needs to be awake. For instance, a sensor will be awake for a specified time during which it will transmit to a base unit. Also, if that same sensor is a repeater for two other sensors, then the repeater sensor will also have to be awake for the specified time periods during which those other two sensors are awake. For instance, sensor S4 will be awake during its time slot, slot 9, as well as during the time slot of S6, slot 6, and sensor S7 will be awake during its time slot, slot 8, as well as during the time slot of sensor S3, slot and sensor S2, slot 3. When acting as a repeater, a sensor will transmit received data and will include the address of the originating sensor so that the base unit will know which sensor is attributable for received data.

In an embodiment of the invention, each of the plurality of sensors will be able to connect to a base station. The base station is enabled to update each of the wireless sensors. The update will be accomplished via a wireless network. It is understood that in a large facility, the ability to locate and interact with sensors is not often easy. Many times, sensors are located in hard to access locations and may require the movement of large equipment. The ability to update the wireless sensors eliminates this physical task of locating the sensors.

In addition to wireless updating of sensors, sensors may also need to be serviced physically nonetheless. In an embodiment of the invention, locating the sensors is a primary task to such service. It is understood that this service may include battery replacement, repair or other service that is understood in the art. In an embodiment of the invention, a portable device, such as a smart phone or similar specialized device, is utilized to hone in on the location of each particular sensor. An initial step is for the device, or smart phone, to command a sensor to be located. This command, and receipt by the sensor, will initiate a transmission by the sensor. The device, or smart phone, is enabled to detect the relative amplitude of the signal that it then receives from the sensor. The device, or smart phone, is further enabled to display the relative amplitude of the signal that it is receiving. This allows a user to move in an area and determine when it is closer to a sensor. The sensor locations are more easily determined in this manner. A smart phone is a mobile phone with more advanced computing capability and connectivity than a basic feature phone. A smart phone may operate on an operating system that allows utilization of features such as a touchscreen computer, including web browsing, Wi-Fi, and 3^{rd}-party apps and accessories. It is understood that smart phones and accompanying applications may allow for a smart phone to receive and transmit a variety of different known signal types, read barcodes and process data.

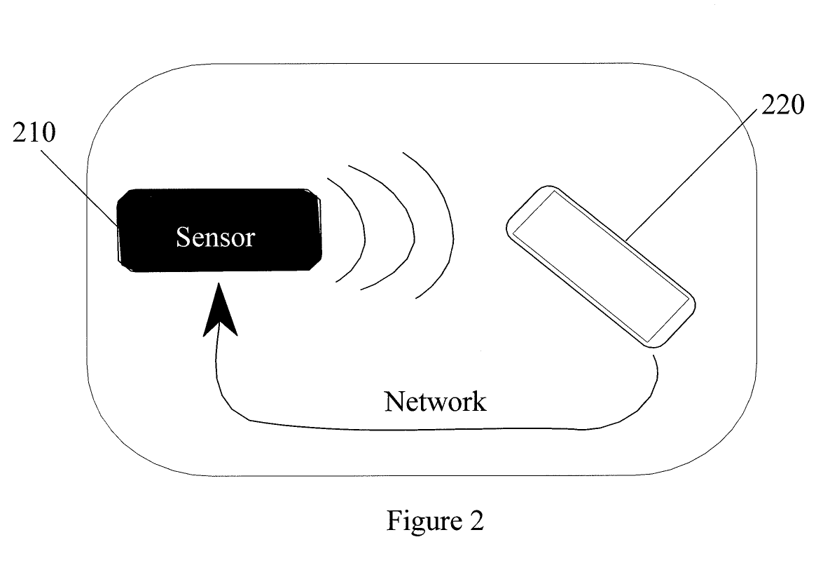

FIG. 2 shows a sensor using a signal to transmit to a location device. A sensor 210 is enabled to transmit a signal which is detectable by a device 220. As noted, the device 220 may be a smart phone type device or other device that is capable of sending and receiving signals. The smart phone, or other device, may operate in a manner that allows for transmission to a sensor and receipt of sensor signals through the use of a software application (App) that is downloadable to the device 220. In this way, the app, as well as the sensors, are updateable over wireless connections.

In a related embodiment of the invention, a sensor may have an LED (Light Emitting Diode) indicator and audible alarm. The LED and audible alarm may be utilized in the sensor location process. For instance, upon receipt of a command from the device 220, or base station, the sensor 210 may be commanded to illuminate a small LED to provide a more prominent visual alert. Further, the sensor 210 may be commanded by the device 220, or base station, to produce an audible alarm. The audible alarm from the sensor 210 is used similarly to the LED indicator to provide ease in location. The audible alarm and LED indicator can be used together or separately. For instance, a device 220, or base station, can command that a sensor 210 activate its LED indicator. If the LED indicator is unsatisfactory in locating the sensor 210, the device 220, or base station, can command that a sensor 210 activate its audible alarm. As is understood, the LED indicator and the audible alarm may be activated simultaneously. Also, a user with a mobile device 220 may directly control the activation of the LED and audible alarm. The user, through the use of an App, can command the base station to produce whichever alert is desired. The use of alerts can be used independently, or in conjunction with the location signal discussed above. It is understood that the location signal, while similar to the audible alert, is operationally different. The location signal of a sensor 210 will produce a signal in a form that is sensible by the device 220. That signal may be a Radio Frequency (RF) signal or an ultrasonic signal. Those skilled in the art will understand that other types of signals are useable by a sensor and transceiver and the embodiments of the invention are not limited to an RF or ultrasonic signal. These may include, but are not limited to, Near Field Communications (NFC). Those skilled in the art will understand that NFC is a set of standards for smartphones and similar devices to establish radio communication with each other by touching them together or bringing them into proximity with each other. NFC can include a variety of protocols and data exchange formats and are based on existing radio-frequency identification (RFID) standards. NFC may be used to instantly pair a sensor and a device. The pairing may be disabled automatically on both the sensor and the device once the desired task has been completed. Further, as is understood by those skilled in the art, RF signaling techniques may use triangulation methodologies. Triangulation is a process by which the location of a radio transmitter can be determined by measuring either the radial distance, or the direction, of the received signal from two or three different points. Triangulation is sometimes used in cellular communications to pinpoint the geographic position of a user.

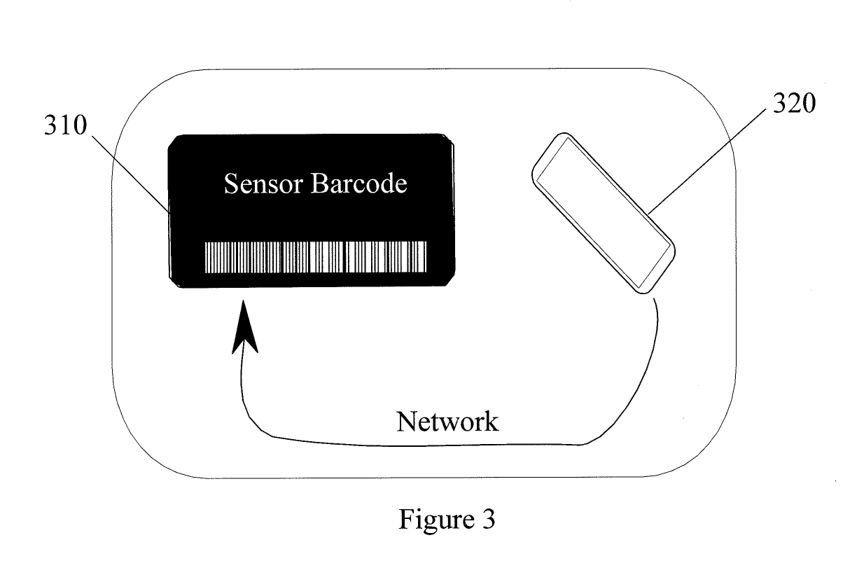

FIG. 3 shows a barcode of a scanner. A barcode 310 can be used by a device 320 to validate the identity of a found sensor. The device 320, such as a smart phone or other device, is enabled to scan and read the barcode 310. The skilled in the art will understand the functions necessary in a barcode reader, and associated technology in a smart phone, necessary to read and understand a barcode. Any visually apparent coding may be used. The embodiments of the invention are not necessarily limited to barcodes. As is understood, a barcode is an optical machine-readable representation of data relating to the object to which it is attached. Though a barcode showing varying widths and spacings of parallel lines is shown in FIG. 3, it is understood that any geometric patterning capable of expressing an identity is included. It is understood that scanners and interpretive software available on devices including smartphones and any other mobile device is included.

If a sensor is located a user can scan the associated barcode. A configuration page associated with the identified sensor is displayed on the device or to a connected display. The configuration page can list a variety of information related to the sensor. The information can include configuration status (whether an update is required), battery status, transmission history and any other type of information that is useful to a user.

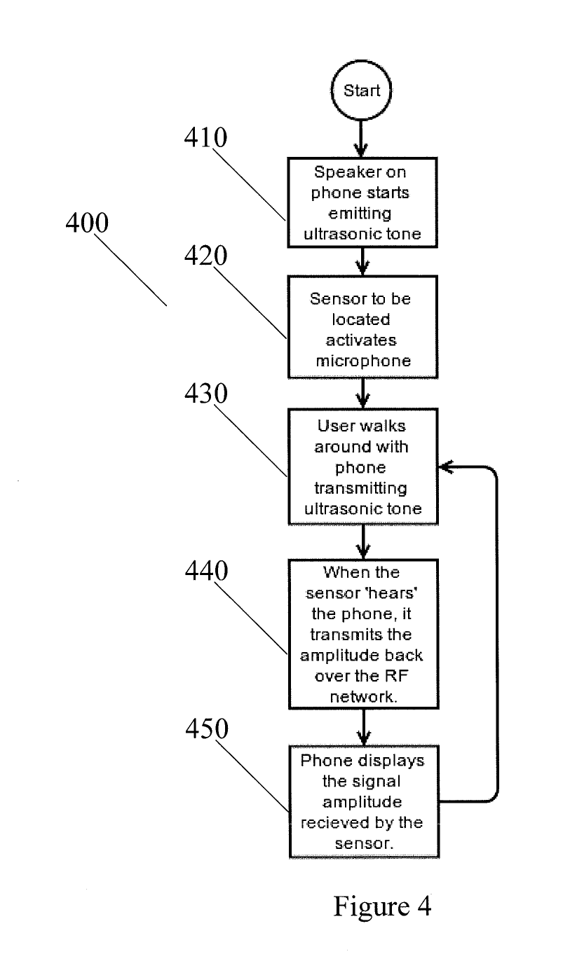

FIG. 4 shows a flow diagram for locating a sensor. In a first step 410 of the method 400, a speaker on a device, or smart phone, emits a signal. This signal may be an RF signal, an ultrasonic tone, or other signal capable of being detected by a sensor. The sensor which is being searched for will activate its microphone 420. Since it is known which sensor is desired to be found, a base unit may signal a sensor to listen for a signal to be emitted from a device, or smart phone. A user with a device, or smart phone, which is emitting a signal, will roam 430. The activated sensor from step 420 will sense the signal emitted from the device, or smart phone, and transmit the amplitude of the sensed signal 440. The amplitude transmission by the sensor may be transmitted back over a RF network utilized by all of the sensors in the network in the normal course of transmission discussed in this disclosure, as an example. It is understood that any means of amplitude transmission is possible as long as the device, smart phone, is enabled to receive the amplitude transmission signal. The device, or smart phone, will receive the amplitude transmission of the sensor and display the amplitude received by the sensor 450. As the user continues to roam, the amplitude transmission will indicate a greater or lesser amplitude received by the sensor (shown in FIG. 4 as step 450 returning to step 430). As the display indicates a lesser amplitude, a user will understand that they are getting farther away from the desired sensor. As the display indicates a greater amplitude, the user will understand that they are getting closer to the desired sensor. A user will locate the desired sensor accordingly.

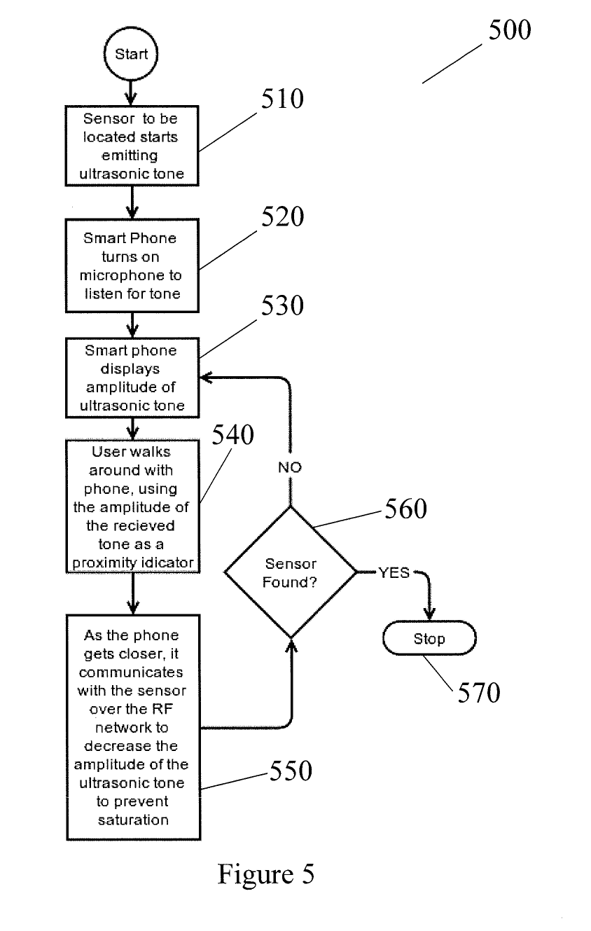

FIG. 5 shows a flow diagram for locating a sensor using a signal from the sensor. In a first step 510 of the method 500, a sensor to be located will emit a signal. This signal may be an RF signal, an ultrasonic tone, or other signal capable of being detected by a device, or smart phone. The sensor can be activated to emit a signal due to a command from a base unit. A device, or smart phone, which is being used to locate the signaling sensor, will activate a microphone 520. The device, or smart phone, will detect the emitted signal from the signaling sensor and display the amplitude of the detected signal 530. A user operating the device, or smart phone, will roam 540 and the displayed amplitude is used as a proximity indicator 540, similar to the method of FIG. 4. As the device, or smart phone, gets closer to the signaling sensor, the device will indicate the proximity and will likewise signal the sensor to decrease the amplitude of the signal 550. This will aid in limiting saturation due to the strength of the emitted signal. The phone may signal for the decrease over the RF network used by the sensors in the normal course of communicating with the base. The device, or smart phone, will continue to display the amplitude, and proximity, of the sensor until the sensor is found 560. Once the sensor is found, the device, or smart phone, can signal to the sensor to stop emitting 570.

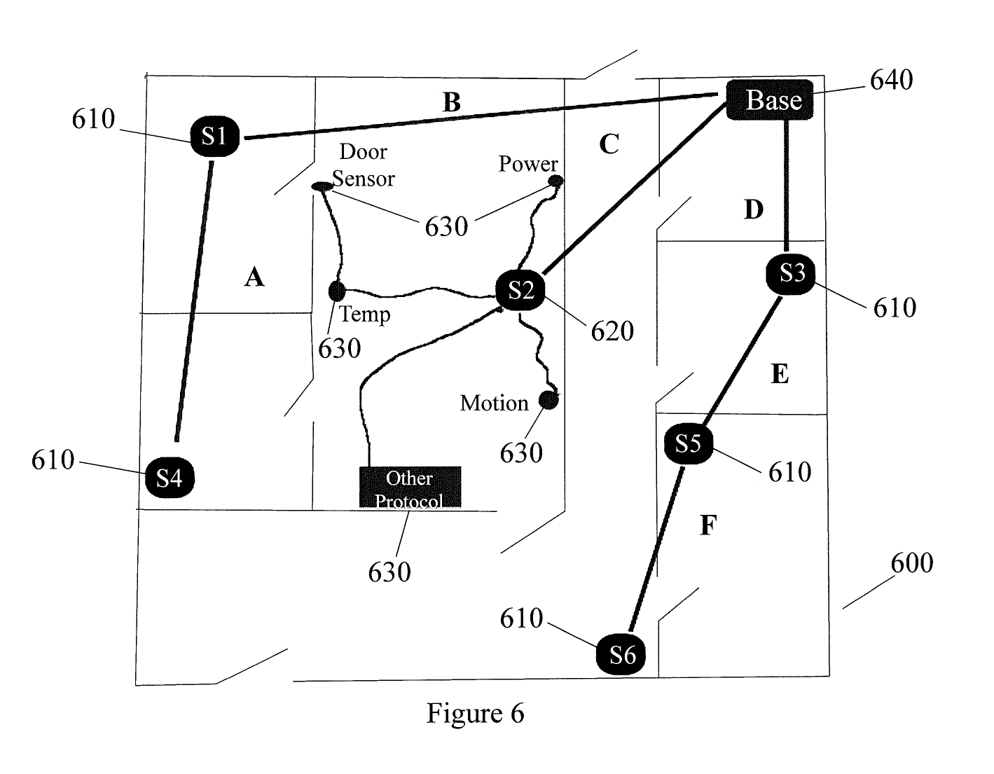

FIG. 6 shows a plug and play functionality in a sensor system. In an embodiment of the invention, a plug and play functionality is enabled. A plug and play functionality allows other wired sensors to be attached to a system 600. A plurality of wireless sensors 610, which may include S1, S3, S4, S5 and S6. Sensor S2 620 may also be a wireless transmitter. Sensor S2 has a plurality of wired sensors connected to it. Sensor S2 is enabled to recognize a wired sensor that is plugged into it. The wired sensors 630 will be automatically recognized by the system 600 as sensors in the network. Interface numbers and sensor names may be utilized to identify a wired sensor that is plugged in. The Sensor S2 620 will sense that a wired sensor 630 has been plugged in. The Sensor S2 620 will exchange information with the wired sensor 630. The Sensor S2 620 will exchange information with a base station 640 similarly to the identification of a wireless sensor 610.

In an embodiment of the invention, a wireless network is not limited to a designated set of sensors. Any number of new devices is connectable. When a new device is connected, a protocol will be utilized for recognizing that a new device is connected. The protocol and communications from a new sensor will include what type of sensor it is and what its capabilities are. The network is enabled to accommodate any type of system. In the event that a device is connected to a network that is new to the system, the system can identify the type of sensor that it is and download any necessary software needed to work with the sensor.

A network is provided which allows forward compatibility. This is similar to USB (Universal Serial Bus) which does not need to know every device that will ever be connected to it. Forward compatibility or upward compatibility (sometimes confused with extensibility) is a compatibility concept for systems design, as is backward compatibility. Forward compatibility aims at the ability of a design to gracefully accept input intended for later versions of itself. The concept can be applied to entire systems, electrical interfaces, telecommunication signals, data communication protocols, file formats, and computer programming languages. A standard supports forward compatibility if older product versions can receive, read, view, play or execute the new standard. The applicability of a forward compatible system with new versions requires not only the respecting of the older version by the designers of the newer version but additionally some agreement on future design features with the design freeze of current versions. The introduction of a forward compatible technology implies that old devices partly can understand data generated by new devices. A base unit in a network can query a new sensor to determine the new sensor's capabilities without manual configuration. This includes the ability of one physical sensor to appear to the network as multiple devices, similar to endpoints in a USB standard.

As is noted above, in the use of systems with wireless sensors, the battery life of batteries in the sensors can be impactful. For instance, in a system with a hundred or more sensors, a short average battery life would result in extensive man-hours locating and replacing batteries. As such, prolonging the battery life in a sensor reduces. Several factors are impactful on battery life. Those factors may include, but are not limited to 1) the amount of time that a sensor is awake to transmit and receive communications (Ta), 2) the transmission power of the wireless radio in a sensor (Pt), 3) the amount of time that it takes for a sensor to transmit and receive data (Tt), and 4) the update frequency of a sensor (TO, which may be set according to preferences of a user. The Ta, Pt, Tt and Tf of a sensor are adjustable parameters.

The transmission power (Pt) required in a sensor is proportional to the distance between two nodes. This may include any objects that may be blocking the transmission path. Blockages naturally increase the required transmission power. The greater the transmission power of a sensor, the greater the drain on a battery per transmission. The time awake (Ta) depends on a number of variables. For instance, a sensor may be being utilized as a repeater. In such a case, the sensor must be awake for longer periods of time in order to receive data from other sensors and then re-transmit that data to a base station. A sensor being used as a repeater can be battery powered or mains powered. Mains power is when an AC adapter is connected to the sensor that draws power from a power line in a building. A sensor being used as a repeater with accessible mains power is optimized differently than a sensor being used as a repeater with only battery power. The time awake (Ta) needs to be balanced with the transmission power (Pt) and the update frequency (TO. A base station will coordinate all network routes and automatically configure a static routing table. In an embodiment of the invention, the amount of energy of a sensor is calculated as follows:

E=[(Pt*Tt)+Ta]*Tf

Energy equals product of the transmission frequency and, the product of the transmission power and the transmission time, plus the sensor awake time.

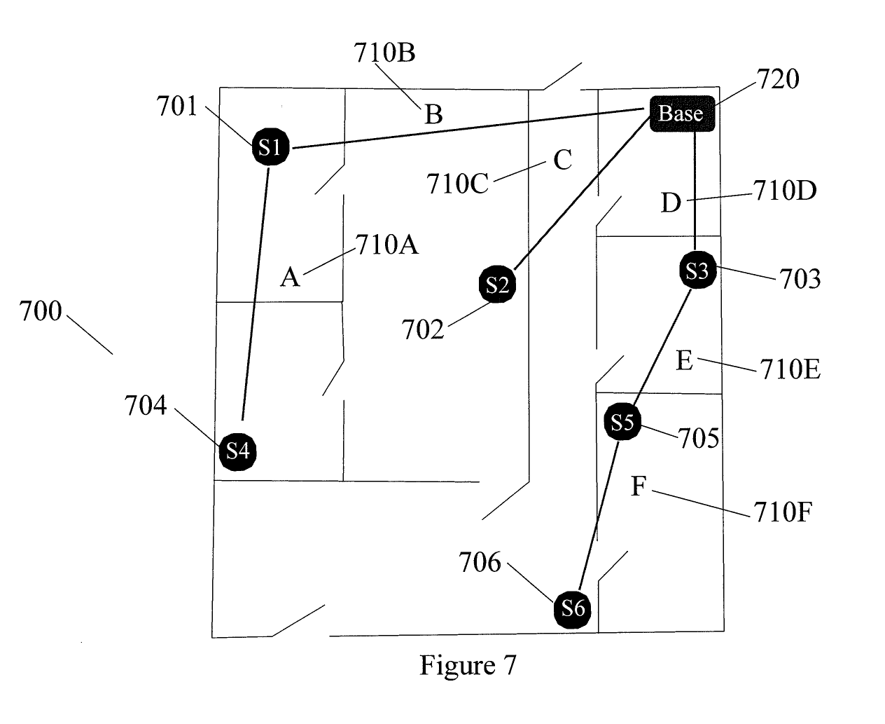

FIG. 7 shows a network with mains power. The network 700 shows a plurality of sensors S1 701, S2 702, S3 703, S4 704, S5 705 and S6 706. The network also has a set of routes through which each of the plurality of sensors will communicate with a base 720. Sensor S2 702 communicates with sensor S1 701 through route A 710A. As such sensor S1 701 acts as a repeater for sensor S4 704 and communicates with the base 720 via route B 710B. Sensor S2 702 communicates with base 720 via route C 710C. Sensor S6 706 communicates with sensor S5 705 via route F 710F. Sensor S5 705 acts as a repeater for sensor 6 706. Sensor S5 705 communicates with sensor S3 703 via route E 710E. Sensor S3 703 acts as a repeater for sensor S5 705. Sensor S3 703 communicates with the base 720 via route D 710D. A variety of different routes are possible. For instance, sensor S1 701 could communicate with sensor S2 702 with sensor S2 702 acting as a repeater for sensor S1. Also, sensor S5 705 could communicate with sensor S2 702 with sensor S2 702 acting as a repeater for sensor S5 705. It is understood that there are even more possibilities of routes. The routes are optimized to minimize the energy utilized. For instance, the power necessary for sensor S5 705 to transmit to sensor S2 702 may be different than the route shown in route E 710E. However, this would require that sensor S2 702, which may require more energy to transmit than sensor S3 703. Since sensor S2 702 or sensor S3 703 is acting as a repeater for sensor S5 705 the repeated transmission requirements of the repeater also needs to be considered. As shown in the example of FIG. 7, the sensor S3 703 is closer to the base 720 than the sensor S2 702, so the repeated transmissions from sensor S3 703 would require less energy.

In an embodiment of the invention, fault detection and fault tolerance are accounted for in a network 700. As noted herein, the network 700 may be optimized for low power consumption as discussed in connection with FIG. 7. The network 700 is enabled to reroute signals based on fault detection and fault tolerance. The network 700 will adapt to a failure and find another route for a signal if possible. For instance, the signal from sensor S1 701 via route B 710B may fail. This may be for a number of reasons, such as an unknown blockage, an unknown interference from outside the network 700, a weak battery in sensor S1 701 or other reason. The network 700 can reroute sensor S1 701 signals. A signal from sensor S1 701 can be routed to sensor S2 702. This may be sufficient to overcome a fault detection where the signal route from sensor S1 701 to sensor S2 702 does not produce a fault. However, it is understood that such a reroute may not overcome a fault. In such an instance, the base may determine that sensor S1 701 is not functioning. A fault code may be issued by the base 720 for sensor S1 701 to be serviced. However, this means that any sensors that used sensor S1 701 as a repeater also need to be rerouted. In the case of the example of FIG. 7, sensor S4 704 signals use sensor S1 701 as a repeater. In the event of the failure of sensor S1 701, sensor S4 704 signals are rerouted via a new path to sensor S2 702. Sensor S2 becomes the new repeater for sensor S4 signals.

In both of the examples of rerouting of signals based on a failure, or tolerance, of sensor S1 701, the signals from a single sensor are rerouted. Either sensor S1 701 is rerouted to accommodate a weak or blocked signal, for example, or sensor S4 704 is rerouted to accommodate a failure of sensor S1 701. However, in some cases more than one sensor may be rerouted. As an example, sensor S1 701 may indicate that its battery is low and in need of replacement. This may be the same situation mentioned above where sensor S1 701 needed to be rerouted to lower the transmission power to conserve its battery life, for example. As noted in this description, a sensor's power consumption may be increased if that sensor acts as a repeater. Accordingly, both sensor S1 701 and sensor S4 704 may be rerouted to sensor S2 702. This saves battery power for sensor S1 701 on two fronts. First, sensor S1 701 need transmit a shorter distance to sensor S2 702 than previously to the base 720. Also, sensor S1 701 need no longer act as a repeater for sensor S4 704 since sensor S4 704 is also rerouted. While the system is generally optimized for low power consumption, such optimization may be dynamic to account for fault detection and tolerance.

To determine if a new route is required for a particular node, as explained above, a simple timeout is used. If a base unit does not receive an expected signal from a sensor, the base unit will determine a different route based on the methods and systems disclosed herein.

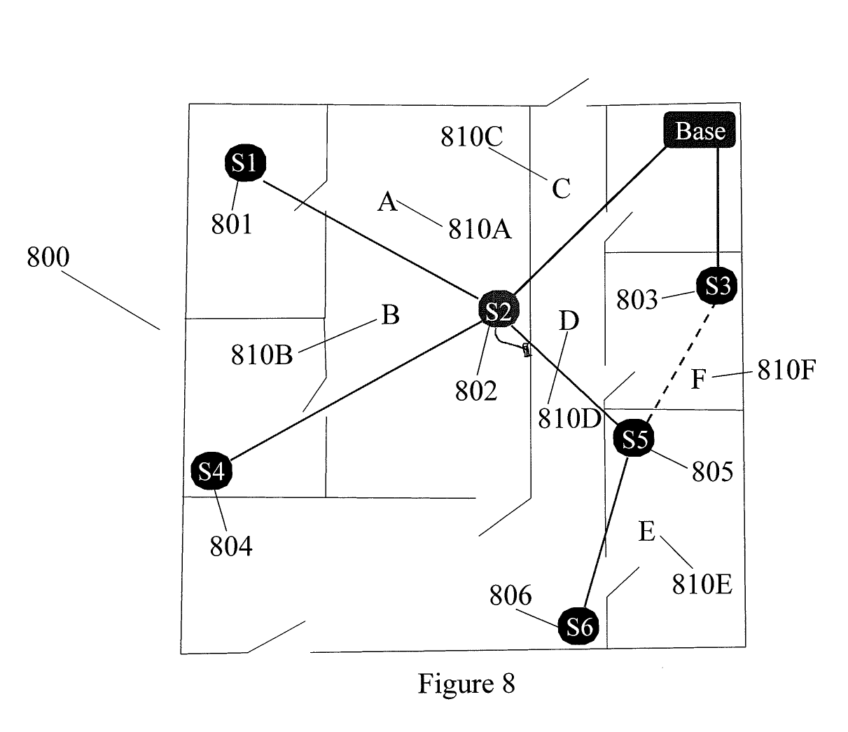

FIG. 8 shows a network with a sensor connected to mains power. The network 800 shows a sensor configuration similar to that of FIG. 7. Shown is a sensor S1 801, sensor S2 802, sensor S3 803, sensor S4 804, sensor S5 805 and sensor S6 806. Also shown is a base 820. When a sensor is plugged in a mains power, the base will automatically recognize that the power source of the sensor has changed. The sensor is enabled to transmit this information to the base 820. In FIG. 2, it is shown that sensor S2 802 is plugged into mains power. This sensor will automatically become a repeater node in the network 800. It is understood that any sensor plugged into mains power can become a repeater node. Since sensor S2 802 is connected to mains power, the batter power consumption of sensor S2 802 is no longer a consideration. The base 820 will optimize the network 820. In doing so, the base will consider sensor S2 to be a “zero power use” node. This means that the battery life of the node is not a consideration because the node, while plugged in to mains power, will not use any battery power. The optimization of the network may result in a change of routing of signals. The optimization may, or may not, change the routing for other sensors. In the example of FIG. 8, sensor S4 804 and sensor S1 are changed so that they route (810A and 810B respectively) their signals through sensor S2 802. This is because the distance for transmission is shorter and sensor S1 801 is no longer required to be a repeater for sensor S4 804, which also conserves power. The transmission power (Pt) of sensor S1 801 and sensor S4 804 is reduced. Sensor S3 803 does not change its route F 810F because the distance to the base 820 is shorter than the distance to the repeater node. Sensor S6 806 also does not change its rouge E 810E because the distance to sensor S5 805 is shorter than the route to the repeater. The overall power consumption of sensor S6 806 and sensor S5 805 is less with sensor S5 805 acting as a repeater for sensor S6 806 than if sensor S6 806 transmitted directly to the repeater. The sensor S2 802 can transmit to the base 820 via route C 810C and awake time (Ta) is not a consideration. Also, sensor S3 803 may transmit to sensor S5 805 via route F 810F if the calculation was that this conserved power if it were closer to sensor S5 805 than to the base 820.

Not shown in FIGS. 7 and 8 is a visual indicator. As noted here in this disclosure, a visual indicator may be activated by the base, for example, or by the device, or smart phone, by commanding the sensor to activate its LED. The visual indicator may be activated when the sensor is commanded to emit a location signal. The visual indicator may also be activated when the device, or smart phone, indicates a certain proximity to the sensor. The proximity requirement for a visual indication may be controlled by the device, or smart phone, or by the base and may be adjustable to accommodate different requirements.

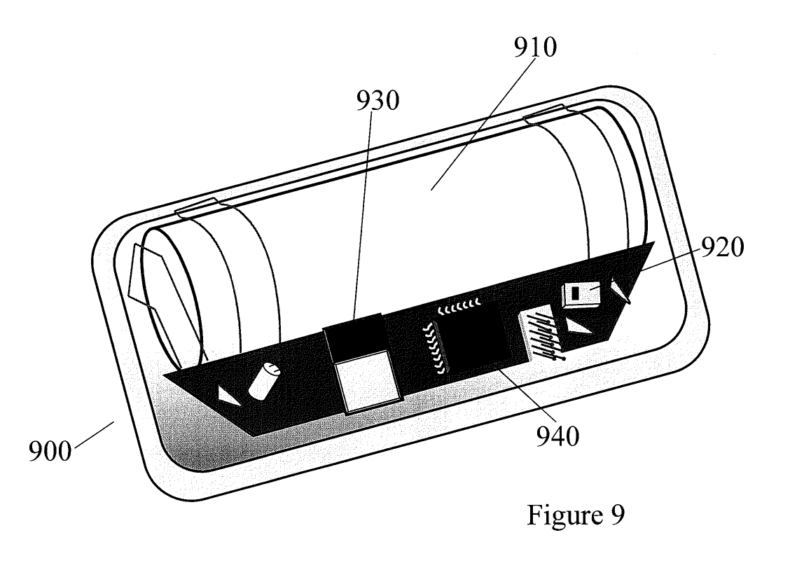

FIG. 9 shows a sensor. The sensor 900 comprises a battery 910 and a transmitter 920. The transmitter 920 may be capable of transmitting an RF signal, an ultrasonic signal or other type signal. It is understood that there may be more than one transmitter 920 in a sensor 900 where each transmitter is capable of transmitting in a certain manner. The additional transmitters are not shown. An LED 930 is enabled to provide a visual indicator. The transmitter 920 may also act as a transceiver. It is understood that there may be a separate transceiver in a sensor. A separate transceiver is not shown. The sensor comprises a chip 940, or other capable device, which operates the various components of the sensor 900. The chip 940 is capable of being wirelessly updated via information received at the transceiver 920.

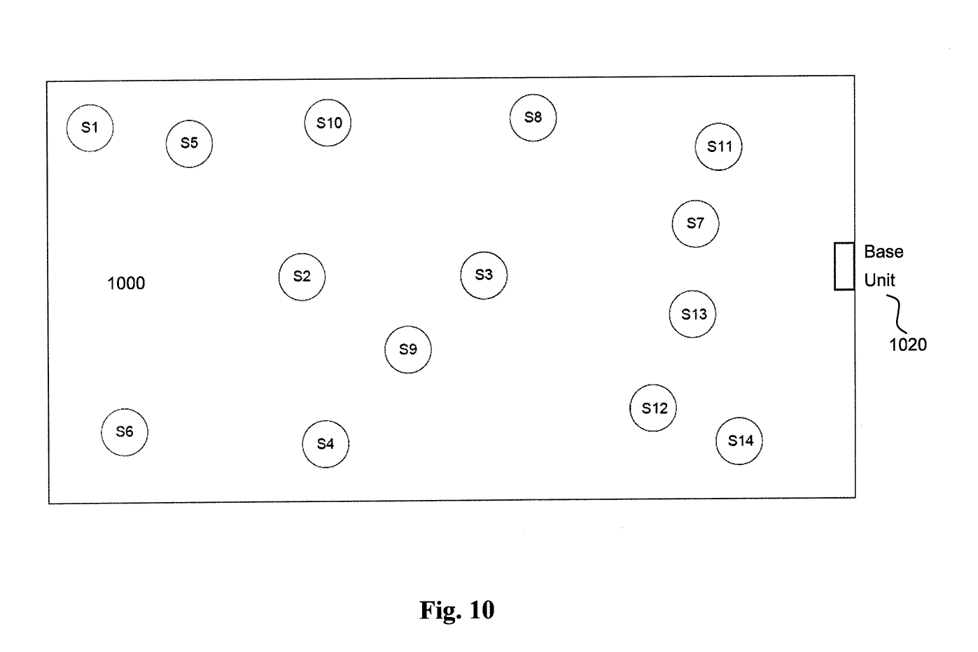

FIG. 10 shows an example of physical sensor locations. In an example placement scenario, a user will locate each sensor to provide optimal RF performance. RF performance optimization will improve the battery life of sensors due to efficient power usage. Essentially, the required power needed for transmission decreases with ideal, or near ideal, placement of sensors. In the placement of sensors, a user may be provided an indication of a variety of variables that relate to sensor placement with regard to a base unit as shown in FIG. 1. The placement indications are real-time and may include the following variables:
Signal quality in the form of 1) raw dBm value, 2) percentage of full strength, 3) total amount of power required for successful transmission, and 4) TX/RX error rate;
The estimated battery life, computed from one or more of 1) reception signal strength, 2) sensor update rate, 3) detected RF channel noise levels, 4) TX/RX error rate, 5) RF frequency, 6) spread spectrum frequency hopping scheme, 7) sampled TX/RX error rate, 8) repeating device requirements, 9) antenna style, 10), distance, and 11) light conditions (e.g., solar powered sensors).
   It is understood by those skilled in the art that other factors may be used, or developed, that may provide an indication to a user of signal quality or estimated battery life, or both. The above examples are not intended as an exhaustive list of possible variables.

The indications to the user of signal quality or estimated batter life, or both, may be communicated by one or more methods. For instance, the sensor being placed by the user may emit an audible tone that varies in frequency (tone) for either signal quality or estimated battery life. The sensor may also emit an audible tone that varies in period proportional to the signal quality or estimated batter life. The sensor may also emit an audible tone that varies in amplitude proportional to signal quality or estimated batter life. The sensor may also be provided with a light, such as an LED, that blinks with a frequency proportional to signal quality or estimated batter life. The sensor may also be provided with a visible light, such as an LED, that changes color in proportion to signal quality or estimated batter life. It is noted that a combination of audible and visual indications may also be provided by a sensor. Or, sensors may be provided with a means to switch from one type of indicator to another type of indicator depending on environmental conditions, such as noisy environments that disallow easy perception of audible tones or very bright environments that may disallow easy perception of visual indicators.

Indicators at a mobile device or at a computer may also be provided to a user. A display on such a device may provide, for example, a graph, bar or line, with relation to time. An audible or visual indicator, such as those mentioned above, may also be emitted from such a device.

In regard to the example locations in FIG. 10, a user may wish to place a sensor, or a plurality of sensors in the room 1000 depending on the size of the room and the nature of the sensors. The potential sensors may be placed in “placement mode” using a web, or wireless, interface. It is understood that there may be other methods of placing a sensor in a particular mode. Those skilled in the art will be familiar with such methods. The user will then move around the room 1000 with a first sensor, S1 for example. Through trial and error, the user will receive the highest indicator for the sensor. At such a location, the user may mount the sensor and change the mode of the sensor off of “placement mode”.

The above example may also be used in connection with a mobile device or computer. The user may place the sensor in “placement mode” as indicated above. The user may then open a sensor page on a mobile device or computer. The user will move the sensor around in a trial and error manner described above. The mobile device will display a real-time signal quality or estimated batter life indicator. The sensor may be sensor S1 and may be using sensor S2 as a repeater. The display on the mobile device or computer may show the signal quality or estimated batter life of the current sensor, S1, as well as the signal quality or estimated batter life of the sensor, S2, being used as a repeater.

It is understood that all of the example sensors, S1-S14, may not be actually placed in a real life scenario. One or more, or all of the sensors may be placed as shown. For example, sensors S14 and S11 may be placed first and may provide sufficient coverage for a portion of the shown area 1000. Second level sensors such as S9 and S10 may then be placed using the first placed sensors as repeaters, or may communicate directly with the base unit 1020. Successively, sensors may be placed until sufficient coverage of an area is accomplished. The communications scheme of the sensors, S1-S14, in the event that all are placed as shown, may result in a time schedule and routing scheme as shown in FIG. 1.

The foregoing description is considered as illustrative of the principles of the invention. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

The embodiments of the invention in which an exclusive property or privilege is claimed are defined as follows:

1. A method of locating a sensor in a network comprising a plurality of sensors and a base unit, said method comprising:
via a location device, emitting a signal detectable by at least one of said plurality of sensors;
activating a microphone in said at least one of said plurality of sensors;
via a user, moving said device from a first location to a second location;
via said at least one of said plurality of sensors, detecting the signal emitted by said location device; and
via said at least one of said plurality of sensors, transmitting a responsive signal to indicate proximity of said locating device to said at least one of said plurality of sensors.

2. The method of claim 1, wherein said location device is a smart phone.

3. The method of claim 1, wherein said process of emitting a signal detectable by at least one of said plurality of sensors comprises emitting an ultrasonic tone detectable by at least one of said plurality of sensors.

4. The method of claim 1, wherein said process of transmitting a responsive signal to indicate proximity of said locating device to said at least one of said plurality of sensors comprises transmitting an RF signal to indicate proximity of said locating device to said at least one of said plurality of sensors.

5. The method of claim 4, wherein said responsive signal to indicate proximity comprises an amplitude of the received location device transmitted signal.

6. The method of claim 1, said method further comprising, via said at least one of said plurality of sensors, emitting an audible alarm based on a command from said base unit.

7. The method of claim 1, said method further comprising, via said at least one of said plurality of sensors, emitting a visual indication based on a command from said base unit.

8. The method of claim 1, said method further comprising, via said at least one of said plurality of sensors, emitting an audible alarm based on a command from said base unit and emitting an visual indication based on a command from said base unit.

9. The method of claim 1, said method further comprising, via said location device, scanning a barcode in said at least one of said plurality of sensors and displaying a configuration page on said location device.

10. A method of locating a sensor in a network comprising a plurality of sensors and a base unit, said method comprising:
via at least one of said plurality of sensors, emitting a location signal;
via said location device, detecting said location signal;
displaying a location metric related to said detected location signal on said location device;
via a user, moving said location device from a first location to a second location;
if said second location is closer to said at least one of said plurality of sensors than said first location, via said location device, communicating with said at least one of said plurality of sensors to modify said location signal; and
via said at least one of said plurality of sensors, modifying said location signal.

11. The method of claim 6, wherein said location device is a smart phone.

12. The method of claim 6, wherein said location signal is an ultrasonic tone.

13. The method of claim 9, wherein said process of communicating with said at least one of said plurality of sensors comprises communicating via an RF signal with said at least one of said plurality of sensors.

14. The method of claim 9, wherein said location metric is an amplitude indication of said location signal.

15. The method of claim 9, wherein said process of modifying said location signal comprises decreasing the amplitude of said location signal.

16. The method of claim 9, said method further comprising, via said at least one of said plurality of sensors, emitting an audible alarm based on a command from said base unit.

17. The method of claim 9, said method further comprising, via said at least one of said plurality of sensors, emitting a visual indication based on a command from said base unit.

18. The method of claim 9, said method further comprising, via said at least one of said plurality of sensors, emitting an audible alarm based on a command from said base unit and emitting an visual indication based on a command from said base unit.

19. The method of claim 9, said method further comprising, via said location device, scanning a barcode in said at least one of said plurality of sensors and displaying a configuration page on said location device.

20. A system for locating a sensor in a network, said system comprising:
a base unit;
a mobile location device enabled to transmit a signal; and
a plurality of sensors comprising a microphone wherein each sensor is enabled to detect said signal transmitted by said location device and to transmit a responsive signal to indicate proximity of said mobile location device;
wherein said responsive signal varies in strength depending on said proximity of said mobile location device to a sensor that is transmitting said responsive signal.

21. The system of claim 20, wherein said mobile location device is a smart phone.

22. The system of claim 20, wherein said signal emitted by said mobile location device is an ultrasonic tone.

23. The system of claim 20, wherein said responsive signal comprises an RF signal.

24. The system of claim 20, wherein each of said plurality of sensors is further enabled to emit an audible alarm based on a command from said base unit.

25. The system of claim 20, wherein each of said plurality of sensors is further enabled to emit a visual indication based on a command from said base unit.

26. The system of claim 20, wherein each of said plurality of sensors is further enabled to emit an audible alarm based on a command from said base unit and to emit a visual indication based on a command from said base unit.

27. The system of claim 20, wherein each of said plurality of sensors further comprises a barcode and said mobile location device is further enabled to scan said barcodes and display a configuration for a sensor related to a scanned barcode.

28. A system of locating a sensor in a network, said system comprising:
a plurality of sensors wherein each of said plurality of sensors is enabled to emit a location signal and modify said location signal pursuant to a command; and
a mobile location device enabled to detect said location signal, display a location metric related to said detected location signal and command a sensor of said plurality of sensors to modify said location signal pursuant to said location metric.

29. The system of claim 28, wherein said mobile location device is a smart phone.

30. The system of claim 28, wherein said location signal is an ultrasonic tone.

31. The system of claim 28, wherein said command is an RF signal.

32. The system of claim 28, wherein said location metric is an amplitude indication of said location signal.

33. The system of claim 28, wherein said modification of said location signal comprises a decrease in the amplitude of said location signal.

34. The system of claim 28, wherein each of said plurality of sensors is further enabled to emit an audible alarm based on a command from said base unit.

35. The system of claim 28, wherein each of said plurality of sensors is further enabled to emit a visual indication based on a command from said base unit.

36. The system of claim 28, wherein each of said plurality of sensors is further enabled to emit an audible alarm based on a command from said base unit and to emit a visual indication based on a command from said base unit.

37. The system of claim 28, wherein each of said plurality of sensors further comprises a barcode and said mobile location device is further enabled to scan said barcodes and display a configuration for a sensor related to a scanned barcode.

38. A method of estimating battery life in a wireless device in a network comprising a plurality of sensors and a base, said method comprising:
via said base, said base comprising a computing device, calculating the total number of clock cycles that one of said plurality of sensors has been awake; and
calculating the power consumption of said one of said plurality of sensors according to a predefined algorithm.

39. The method of claim 38, wherein said algorithm accounts for time awake of said sensor, transmission power of said sensor, update frequency of said sensor and amount of time that it takes for said sensor to transmit data.

40. A method of optimizing power in a wireless network, said network comprising a plurality of wireless sensors and a base unit, said method comprising:
by said base unit, calculating a power metric for each of said sensors of said plurality of wireless sensors;
for each sensor of said plurality of wireless sensors, establishing a signal route for transmissions that utilizes the least power according to said power metric;
scheduling an awake time for each sensor in said plurality of sensors in a unique time slot during a predefined period of time.

41. The method of claim 40, wherein said power metric accounts for time awake of said sensor, transmission power of said sensor, update frequency of said sensor and amount of time that it takes for said sensor to transmit data.

42. The method of claim 40, said method further comprising, if a sensor of said plurality of sensors receives mains power, transitioning said mains powered sensor into a repeater node for other sensors of said plurality of sensors if it results in a lower power use according to said power metric.

43. The method of claim 40, rerouting said signal route of at least one sensor of said plurality of sensors if a signal path of an other sensor of said plurality of sensors is faulty.

44. A method of optimizing placement of sensors in a wireless network, said network comprising a plurality of wireless sensors and a base unit, said method comprising:
via a user, placing a first of said plurality of sensors in a placement mode;
via said first of said plurality of sensors or a computing device, emitting a human perceptible signal wherein said signal indicates one of a signal quality and an estimated battery life for said sensor; and
via said user, mounting said sensor.

45. The method of claim 44, wherein said human perceptible signal is an audible tone.

46. The method of claim 44, wherein said human perceptible signal is a visible indication.

47. The method of claim 44, wherein said indication of signal quality comprises at least one of:
raw dBm value;
percentage of full strength;
total amount of power required for successful transmission; and
TX/RX error rate.

48. The method of claim 44, wherein said indication of estimated battery life comprises at least one of:
reception signal strength;
sensor update rate;
detected RF channel noise levels;
TX/RX error rate;
RF frequency;
spread spectrum frequency hopping scheme;
sampled TX/RX error rate;
repeating device requirements;
antenna style;
distance of transmission; and
light conditions.

49. The method of claim 44, wherein said computing device is a mobile computing device paired to said first of said plurality of sensors.
